(19) United States
(12) Patent Application Publication
(10) Pub. No.: US 2002/0125833 A1
(43) Pub. Date: Sep. 12, 2002

(54) Curtain-type light bulb string

(76) Inventor: Fong-Shi Lin, Hwei-chou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/803,111

(22) Filed: Mar. 12, 2001

(51) Int. Cl. H05B 37/02

(52) U.S. Cl. 315/185 R; 315/185 S

(57) ABSTRACT

The present invention relates to a curtain-type light bulb string, which includes a main electrical wire connected with several extended branch strings having connected with many bulbs on the string connected in parallel for improving the lighting effect and preventing from a large damage of the entire branch string and the curtain-type light bulb string.

### BACKGROUND OF THE INVENTION

A conventional curtain-type light bulb string includes a main electrical wire and several extended branch strings. Each branch string is provided with many series bulbs to provide lighting effect. Since the bulbs are connected in series, the branch string will be broken whenever any one bulb is damage. The branch string and even the curtain-type light bulb string will not be worked and the lighting effect is no more existed.

Accordingly, the primary object of the invention is to provide a new connecting arrangement of the branch string with different connecting bulbs to overcome the drawback of the prior known design. Now the features and advantages of the present invention will be described in detail with reference to the accompanying drawings.

### BRIEF DESCRIPTION OF ACCOMPANYING DRAWINGS

FIG. 1 is a plan exemplary view showing a curtain-type light bulb string according to the present invention.

FIG. 2 is a plan view of FIG. 1 connecting with a controller according to the present invention.

### DETAILED DESCRIPTION OF PREFERRED EMBODIMENTS

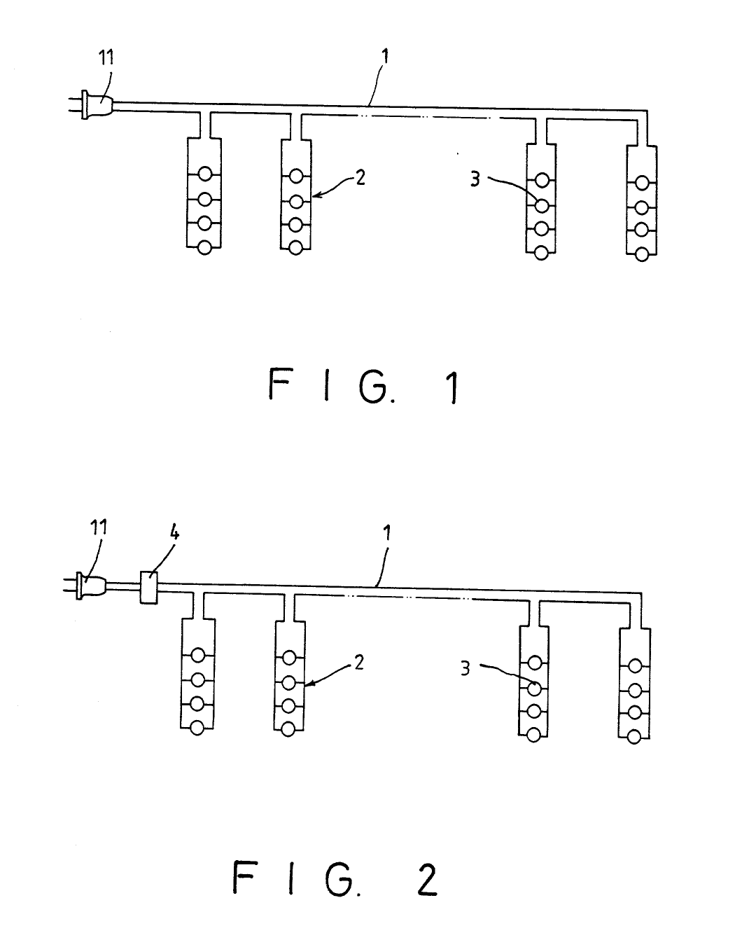

Referring to FIG. 1, the present invention includes a main electrical wire (1) with a plug (11) for connecting an electrical source and several extended branch strings (2) being positioned in interval. The branch string (2) is provided with many bulbs (3), which are connected in parallel on the branch string (2). That is each bulb (3) is connected on the branch string (11) in parallel. If any bulb (3) is broken, other bulbs on the branch string (2) will not be affected. Only the broken bulb (3) is not lighting and it will not be harmful so much to the complete decorative outlook of the light bulb string.

Moreover, when the broken bulb (3) is not lighting, it can be recognized quickly and can be replaced soon. It will overcome the drawback of a conventional series bulb string. As shown in FIG. 2, it is to be understood that a controller (4) can be provided on the main electrical wire (1) to control the voltage or currency for increasing the effect of utility.

As above mentioned, the present invention obviously gains the utility and novelty for patent and is thus applied.

What is claimed is:

1. A curtain-type light bulb string including a main electrical wire and several extended branch strings being connected in parallel, and the characteristic is in that the branch string having been provided with many parallel connected bulbs while each branch string being connected with each other in series

2. The curtain-type light bulb string as claimed in claim 1, wherein a controller is provided to connect with the main electrical wire to control the voltage and currency of the branch string of the curtain-type light bulb string.
